(19) United States
(12) Patent Application Publication
(10) Pub. No.: US 2009/0013660 A1
(43) Pub. Date: Jan. 15, 2009

(54) Operationally Improved Clutch-Driven Landscaping Vehicle

(76) Inventor: John Salazar, Prunedale, CA (US)

Correspondence Address: CENTRAL COAST PATENT AGENCY, INC, 3 HANGAR WAY SUITE D, WATSONVILLE, CA, 95076, US

(21) Appl. No.: 12/172,718

(22) Filed: Jul. 14, 2008

Related U.S. Application Data
(60) Provisional application No. 60/959,458, filed on Jul. 13, 2007.

(51) Int. Cl. A01D 75/00

(52) U.S. Cl. 56/11.7

(57) ABSTRACT

A system for improving maneuverability and safety of a clutch driven landscaping utility vehicle has a set of vehicle track belts comprising of one track belt per set of front and rear wheels, a tension adjuster for controlling tension of the track belts over the wheels, and a track guard for preventing debris from dislodging the track belt during operation.

### CROSS-REFERENCE TO RELATED APPLICATIONS

The present invention claims priority in part to a U.S. provisional patent application Ser. No. 60/959,458, filed on Jul. 13, 2007 and entitled “Super-Track Drive System”, disclosure of which is incorporated in its entirety.

### BACKGROUND OF THE INVENTION

1. Field of the Invention

The present invention is in the field of landscaping including field or yard work and ground preparation and pertains particularly to improving maneuverability and operational safety for clutch-driven utilities such as lawn or brush mowers and the like.

2. Discussion of the State of the Art

In the art of landscaping there exists a wide variety of clutch-driven wheeled utilities adapted to mow, clear brush, mulch, till, trim edges, and to perform other tasks generally required to maintain landscaped environments. Many of these tools are remarkably similar relative to engine type, clutch operation, blade operation, and safety features like blade and engine shut-off switches activated by releasing one's grasp of a spring-loaded bar or the like.

A clutch-driven lawn mower is a good example of a wheeled utility adapted to mow grass and, in some cases mulch grass after it is cut. A typical clutch-driven lawnmower has a hydraulically assisted drive train and wheel assembly that may be activated to move forward under engine power by activating a clutch assembly and may be temporarily idled by releasing the clutch assembly. A user operating a clutch-driven lawn mower saves energy and time while mowing by not being required to physically push the mower. The mower moves by itself as long as the clutch is activated and the drive train is engaged to a wheel of the mower.

A clutch-assisted drive train enables the mower to move with adequate speed over flat ground and up some slight inclines. However, limitations exist relative to the traction achieved by a clutch-driven mower. One limitation relative to traction is that typical lawn mowers have only one wheel in the back powered by the engine through a clutch and drive train. The remaining three wheels of the mower are typically freewheeling and not power assisted in any way. While the arrangement may be suitable on relatively flat ground, inclines of more than a mild rise pose a problem and hazard for an operator trying to mow them with a clutch-assisted mower. A typical mower will lose traction on the incline and may begin to slide back down the incline, especially if an angled approach to the incline is observed.

The limitation mentioned above may pose a safety hazard for an operator attempting to mow a steep incline due to a fact that the operator is positioned behind the mower and therefore positioned down slope from a potential slide of the mower. Many mowers are very heavy and can seriously injure someone if the mower hits them during an uncontrolled slide. Maneuverability of a typical mower is not adequate for most many situations where curbs or other stationary objects present obstacles. Generally speaking, a clutch-driven mower is heavier than a light push mower and has to be wrestled over or around obstacles with the engine and blades off for safety purposes. They are generally too heavy for a user to lift fully off of the ground without risking injury.

Other hazards exist with most brush type and grass type mowers such as a tendency to blow debris out from the sides of the undercarriage housing the cutting blades. Many systems have some type of safety shield installed on the side where debris may be kicked out by the blade but they too are limited to varying degrees relative to the percentage of protection they offer. Blade shields or shrouds are mostly hard plastic and may be broken or cracked by rocks and the like kicked out by the blades. They also may be inadvertently removed from the system by the operator and not properly replaced or replaced at all when the system is again used.

Although most landscaping vehicles such as a mower, brush chipper, mulcher, stump grinder, or even trimmer have kill switches to stop blade rotation and mechanisms that prevent blade rotation when certain other tasks are engaged, the utilities do not have breaking systems per say and may continue to move forward taking the operator by surprise. Still other hazards exist such as a risk of rotating blades hitting objects like downed tree limbs or other objects hidden in taller grass or brush.

Therefore what is clearly needed is an improved clutch-driven landscaping utility that overcomes the limitations described above relative to maneuverability and safety. Such a utility would save more time and require less toil than do conventional systems now in use and would reduce or eliminate incidences of injury associated with normal operation of such utilities.

### SUMMARY OF THE INVENTION

The problem stated above is that maximum maneuverability is desirable for a landscaping vehicle, but many of the conventional means for improving maneuverability, such as clutch-assisted drive trains, provide only limited improvement over push models. The inventors therefore considered functional elements of a landscaping vehicle, looking for elements that aid maneuverability that could potentially be harnessed to provide improved maneuverability for a landscaping vehicle but in a manner that would not compromise safe operation.

Many landscaping vehicles are driven by a clutch-assisted drive train, one by-product of which is an uneven distribution of traction (only one wheel powered) over all of the wheels of the vehicle. Most such vehicles employ clutch-assisted drive trains to enable clutch-assisted forward motion of the vehicle thereby improving maneuverability at least on a flat plane and in a straight forward path. Clutch engagement handles operated from behind the vehicle are typically a part of such apparatus.

The present inventor realized in an inventive moment that if, at the point of clutch engagement, power to the clutch-enabled wheel could be caused to be distributed over all of the wheels on the vehicle, significant improvement in traction and maneuverability might result. The inventor therefore constructed a unique track belt arrangement for the wheels of the landscaping vehicle that allowed the clutch-assisted vehicle to maneuver in a much improved way, but also in a way that was safe to operate for the user. A significant increase in maneuverability results, with no impediment to safety.

Accordingly, in one embodiment of the invention, a system is provided for improving maneuverability and safety of a clutch driven landscaping utility vehicle. The system incorporates a set of vehicle track belts comprising of one track belt per set of front and rear wheels, a tension adjuster for controlling tension of the track belts over the wheels, and a track guard for preventing debris from dislodging the track belt during operation.

In one embodiment the utility vehicle is a lawnmower. In one embodiment the track belt has opposing sidewalls and a center ridge located peripherally about the inward facing service of the belt, the wheels having a center groove located peripherally around the outside surfaces thereof, the grooves adapted to accept the center ridge. In one embodiment the tension adjuster is a bar assembly installed on both ends at the hubs of the wheels. In this embodiment the track guard is installed on the tension bar assembly. In one aspect of the present invention the system further incorporates a pair of cover plates affixed to the lateral sides of a blade housing compartment of the utility vehicle. In a variation of this aspect the utility vehicle is a lawnmower. In this aspect variation, the system is used to vacuum up debris. In one embodiment, the cover plates are bolted or riveted to the blade housing.

In one aspect of the present invention, the system further incorporates an open modified chassis front with a material skirt affixed thereto. In one aspect the skirt is leather. According to another aspect, the system further incorporates an emergency breaking system activated by handle release. In still a further aspect, the system incorporates pivot plates for enabling wheel height adjustment without changing wheel base dimension.

### BRIEF DESCRIPTION OF THE DRAWING FIGURES

FIG. 1 is an elevation view of a wheel track and tensioning system according to an embodiment of the present invention.

FIG. 2 is a sectioned view of the track of FIG. 1 viewed along the section lines AA.

FIG. 3 is an elevation view of the track and tensioning system of FIG. 1 with a track guard integrated into the system.

FIG. 4 is a left-side view of the track guard of FIG. 3.

FIG. 5 is a bottom view of a blade-housing of a lawnmower with a set of cover plates installed according to an embodiment of the invention.

FIG. 6 is a front view of a lawnmower with a material chassis skirt installed according to an embodiment of the present invention.

FIG. 7 is a perspective view of the inside of a lawnmower wheel illustrating a cable-assisted break and plug system according to an embodiment of the present invention.

FIG. 8 is an elevation view of a height adjustment pivot plate for adjusting height without changing wheelbase length.

### DETAILED DESCRIPTION

The inventor provides an operationally improved landscaping utility vehicle that includes several features to improve performance and safe operation. The features comprising a number of improvements are integrated into the hardware and chassis of a landscaping utility vehicle and are described in enabling detail in various embodiments described below.

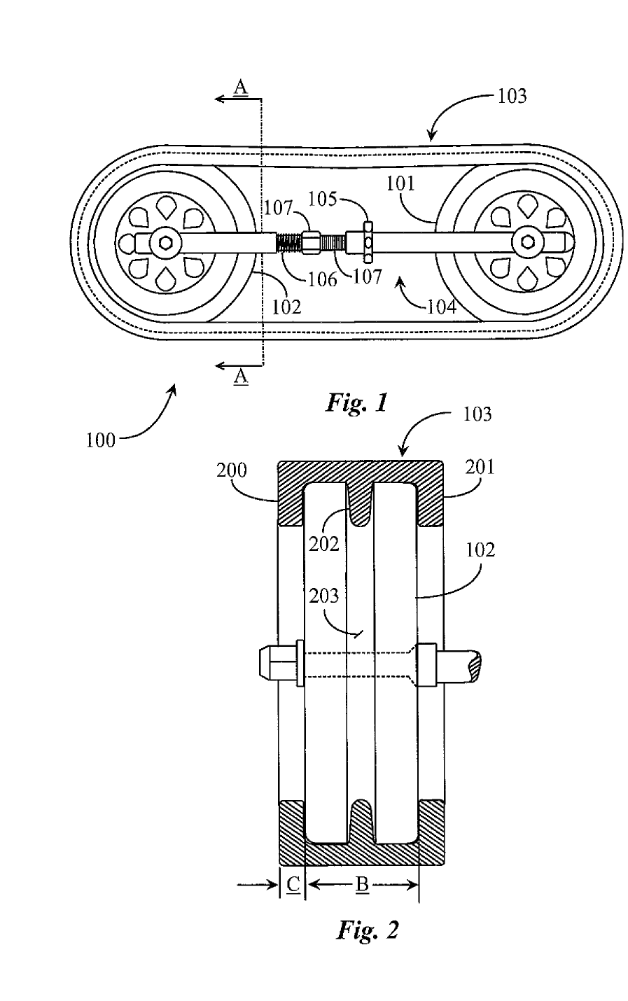

FIG. 1 is an elevation view of a wheel track and tensioning system 100 according to an embodiment of the present invention. System 100 is adapted for a clutch-driven landscaping utility vehicle such as a lawnmower or like walk-behind, clutch-driven utilities. A set of wheel track belts 103 (one track belt illustrated) are provided to fit over the left wheels (one track belt) and right wheels (one track belt). Element 103 will be used hereafter to refer to a single track belt of the set of track belts since both belts are identical to one another and can be interchanged.

Track belt 103 is made of a resilient and flexible material like tire rubber. In one embodiment track belt 103 is molded in one contiguous piece. In another embodiment track belt 103 comprises more than one rubber part welded glued or otherwise seamed together to form the belt.

System 100 includes a wheel 101 and a wheel 102, which together represent one side of a four wheeled clutch driven landscaping utility. In this specification a clutch driven lawnmower serves as a good example of a landscape utility improved by the system of the present invention. However, this should not be construed as a limitation as other landscape utilities may be operationally improved both in maneuverability and in safety of operation with light to moderate modification to hardware and chassis according to embodiments of the invention. Track belt 103 is adapted to fit over the wheel surfaces of wheels 101 and 102 in a manner which locks the wheels into synchronized rotation such that power to one of the wheels transfers through the track belt to the other wheel.

Track belt 103 has a main surface wall that is just wider than the tread surface of the wheel it is adapted to fit over. Track belt 103 has opposing sidewalls that extend inward when installed over a wheel set such that each sidewall covers a portion of the side of each wheel. The differential between the main interfacing surface of the belt and the sidewalls is illustrated in this example as a broken line demarking where the sidewalls interface with the main belt surface. The sidewall features of belt 103 are illustrated in more detail in FIG. 2.

Wheels 101 and 102 may be connected to opposing wheels by axel. Generally speaking, the rear wheel set is powered by the engine and drive train of the landscape utility such as a clutch-driven lawnmower for example. At least one of the two rear wheels of the utility are powered by clutch engagement accomplished by continually holding a clutch-bar down against a handlebar when walking behind the utility. The utility loses power to the wheel if the clutch-bar is released and the vehicle ceases to move forward under power of the engine.

Track belt 103, applied on both wheel sets of the utility, effectively distributes the power over all four wheels of the utility and also provides extra surface tread for gripping the ground when being clutch driven. At least the rear wheels of the utility must be axle-connected with power to one of those wheels for all four wheels to be successfully driven using the track belts. In one embodiment both rear wheels may be powered and controlled by clutches. In this embodiment the wheels do not have to be connected together by axel for all four wheels to be driven successfully using the track belt system. Track belt 103 has a gripping tread provided on the surface of the belt that interfaces the ground. The maneuverability of the utility is greatly improved with track belts 103 installed.

System 100 includes a tension adjuster bar 104 that is installed at either end to the hub of wheels 101 and 102. Tension adjuster bar 104 is adapted to enable a range of length adjustment to the wheel base centerline to centerline dimension. One tension adjuster bar is illustrated in this example. Only one bar is needed one side for axle-bearing utilities that have adjustable wheel hubs. However, in one embodiment two adjustment bars may be provided to keep track belts 103 from slipping against the wheel surfaces and losing traction.

In this example, tension adjustment bar 104 includes a spring 106 a stop nut 107 a threaded shaft portion 107, and a tensioning handle 105 typical of tension bar adjusters. Turning the handle left or right provides adjustment to shorten or lengthen the wheel base with the wheels loosened at their respective hubs. Other methods of providing tension adjustment may be applied in this example in place of bar 104 without departing from the spirit and scope of the invention. Bar 104 represents just one way to provide tension adjustment to reduce or eliminate belt slippage.

FIG. 2 is a sectioned view of track belt 103 of FIG. 1 viewed along the section lines AA. Track belt 103 has a sidewall 200 and a sidewall 201 formed contiguously therewith or affixed thereto by glue, mold, heat-welding, or seaming. In this example, wheel 102 is illustrated with a centering-groove 203 provided peripherally around the outer wheel surface. Groove 203 is provided with a depth dimension and width dimension suitable for accepting a vertical centering-ridge 202 provided peripherally around the inside surface of track belt 103. Ridge 202 aids in keeping belt 103 centered on wheel 102 in addition to the centering properties of sidewalls 200 and 201. Ridge 202 is an optional feature and is not required to successfully practice the present invention relative to maneuverability improvements achieved by tracking the wheels of the utility. It may be provided as an added measure to aid centering of track belt 103 over the wheel and to further reduce the opportunity for slippage of the belt against the wheel.

Track belt 103 has a surface width B taken between the opposing surfaces of sidewalls 200 and 201 that is just larger than the overall width of wheel 102. Sidewall 200 may vary in thickness C however, the thickness provided should be proportional to the flexibility characteristic of the material such that the sidewall functions to keep the track belt over the tire and does not flex away from the tire under normal forces. In one embodiment, longitudinal flexibility of track belt 103 is substantially greater than lateral flexibility owning to manufacturing techniques known in the art of tire manufacture such as the user of fibrous materials and the like in the rubber compound.

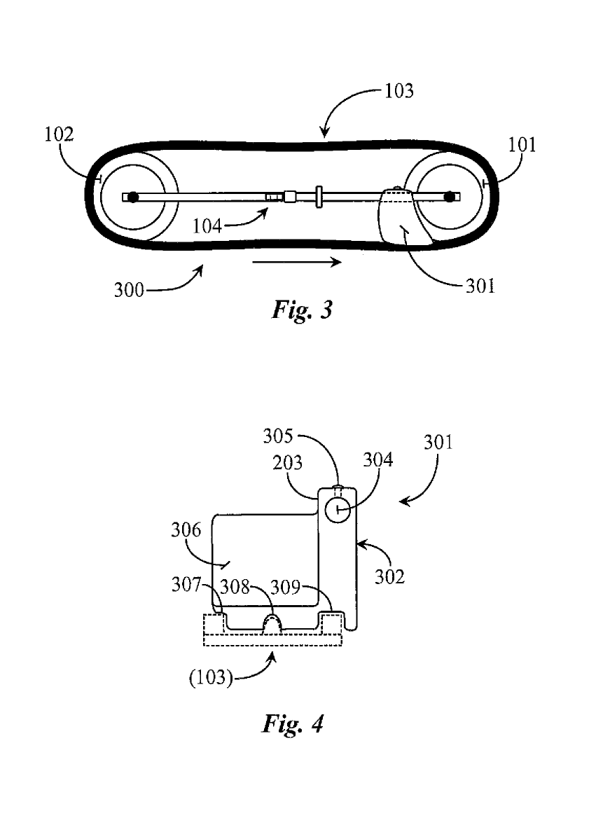

FIG. 3 is an elevation view of a track and tensioning system 300 of FIG. 1 with a track guard integrated into the system. The components of system 300 with the exception of the track guard are identical to those described with reference to FIG. 1 above and therefore shall retain the same element numbers. In this example, track belt 103 is installed over utility wheels 101 and 102 and tensioned using tension adjuster bar 104 as was illustrated with respect to FIG. 1. A track guard 201 is provided in this embodiment and installed near wheel 101 on tension adjuster bar 104. There may be two track guards installed per utility vehicle the guards installed adjacent to the rear wheels of the utility vehicle.

Track guard 201 is adapted to prevent any debris which might be cut or blown onto the inner surface of track belt from being trapped between the inner surface of the belt and the outer wheel surface. Without guard 201, debris may become trapped between the belt and the rear wheel causing the track belt to dislodge from the wheel. Track guard 201 sweeps any material off of the inner surface of the belt before it interfaces with the outer surface of the rear wheel. In this case the rear wheel is wheel 101. A screw or bolt and nut assembly may be used to install the track guard to the tension adjuster bar. In a preferred embodiment there are two guards 201 and tension adjuster bars 104 installed per utility to control track belt tension and maintain track belt integrity on each side of the utility.

Track guard 201 may be manufactured of rubber or a semi-flexible to more rigid polymer material. Molding or machining may be used to fabricate guard 201. Guard 201 may be made contiguously from one material or it may be made in separate parts which are assembled together to produce the guard. In this example, guard 201 has an outer facing wall that is shaped similar to a flexed broom.

In the system of the invention, it is important that the integrity and tension of the track belts be controlled and maintainable both for consistent and reliable maneuverability improvement of the vehicle and for increased safety during operation. If debris causes a belt to dislodge from the wheel, it may flex and throw the debris or the belt be cut by the system blades. Therefore the integration of components herein shall be referred to as an integral system even though the parts are separate and not necessarily physically integrated.

FIG. 4 is a left-side view of track guard 201 of FIG. 3. Track guard 201 has a sidewall 303, which is visible in elevation in FIG. 3. A bore 304 is provided horizontally through sidewall 303 to provide a mounting location for track guard 201 to the tension adjuster bar. The diameter of bore 304 is just larger than the diameter of tension adjuster bar (104) so that track guard 201 may be slid onto bar (104) before installation to the wheel hub of wheel (101). A screw 305 is provided to secure track guard 201 onto bar (104) in a desired position adjacent to rear wheel (101).

Sidewall 303 has a visible surface area 202 that hides other features of the guard when it is installed into position. A guard body 306 is provided to add some weight to the unit and includes a molded or machined shape feature to accommodate placement of the guard so close to wheel 101. For example, the rear surface of feature 306 has a clearance radius similar to the radius of wheel 101 so that the bottom features of the guard may interface with the belt close to the rear wheel.

Guard body 306 including sidewall 303 has a combined width that is larger than the width of wheel 101. The front surface of feature 306 may be vertical or slightly angled down to a pattern of features formed or cut into the bottom surface of guard 201. These are features 307, 308, and 309. A representation of the profile shape of track belt (103) is illustrated in broken boundary to show how features 307, 308, and 309 align to features of the belt, namely the sidewalls and optional center ridge. The bottom surface of track guard 201 slips down into the interior of track belt (103) very close to if not lightly touching or “sweeping” the belt.

The shape profile of guard 201 helps to prevent any jamming or jumping of the belt against the guard if the guard touches the belt as the belt moves in the direction of the slant of the profile shape of the guard as seen in FIG. 3. The bottom surface of guard 201 at feature 309 hangs over and below the outside corner of the sidewall of the track belt. On the opposite side, the bottom surface at feature 307 does not extend fully to the outside corner of the inward facing sidewall. As long as the interior of the belt is covered or “swept” by the guard, no material debris can compromise the installation.

Track guard 201 is installed on tension adjuster bar (104) in the present example. In another embodiment, a track guard may be provided that may be installed to the hubs of each wheel. Similarly, other bracket-type installation hardware could be provided for installing the track guard into position over the track belt and adjacent to the rear wheel using another part of the utility as a mounting surface.

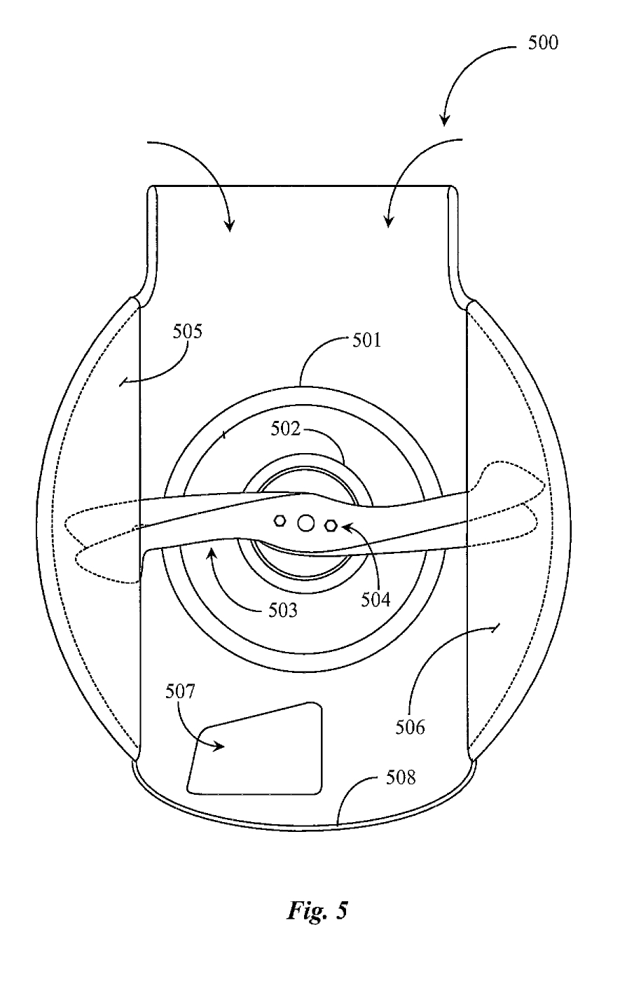

FIG. 5 is a bottom view of a blade-housing 500 of a lawnmower with a set of cover plates installed according to an embodiment of the invention. Blade housing 500 is generally annular in shape to accommodate rotating mower blades 503 mounted by alignment nub and bolts 504 to a blade rotor hub 502. A protective ring 501 is typically provided as part of the housing to protect the belt-driven rotor hub from flying debris. The elevation of the uppermost blade just clears ring 501. In this example, the rear of blade hosing 500 is closed off by a rear housing wall 508. An opening 507 is provided through the chassis wall of the mower to accommodate a mower bag to collect the cuttings. In some models a mulching blade in provided to mulch the cuttings.

In most lawnmower chassis the front end of the blade housing is closed by a front housing wall. In this example, the front housing wall has been removed or cut out of the chassis for the purpose of increasing air flow from the front of the chassis into the housing. Another modification to blade housing 500 comprises the addition of a pair of cover plates consisting of a right cover plate 505 and a left cover plate 506. Cover plates 505 and 506 are strategically located on either side of housing 500 and cover the tips of blades 503. Each cover plate is a piece of sheet metal or other flat, metallic, semi-annular section that is bolted or welded onto the surface of the blade housing.

The function of plates 505 and 506 is to protect the track belt in between the wheels from falling debris on each lateral side of the utility vehicle. This protection is afforded by the fact that the plates extend well over the track belts outside and inside of the chassis. One benefit of adding plates 505 and 506 to blade housing 500 is that it changes the typical airflow dynamics through the blade housing. In a typical lawn mower as the blades rotate in one direction air is forced in a circular pattern and escapes out from under the housing rim in all directions including the front and sides of the mower. Anyone with skill in the art of mowing can attest to the displacement or “blow-off” of leaves, cuttings and the like when the mower approaches. With plates 505 and 506 installed, a venturi effect is created inside the blade housing where the air flow is forced to the rear of the housing and an air intake is created primarily at the front in the direction of the arrows, but also around the periphery of the mower to compensate for the displaced air within the blade housing.

A functional improvement is thus created by the addition of cover plates 505 and 506 in that the mower may also be used to vacuum dirt and other debris such as leaves with the blades running. Addition of the track belts enables the mower to climb much steeper inclines, even at an angle to the slope of the incline without sliding sideways and without being wrestled to maintain position. It may also be driven over obstacles such as curbs, logs, branches, and the like without nicking the blades and without requiring lifting or other strenuous maneuvers.

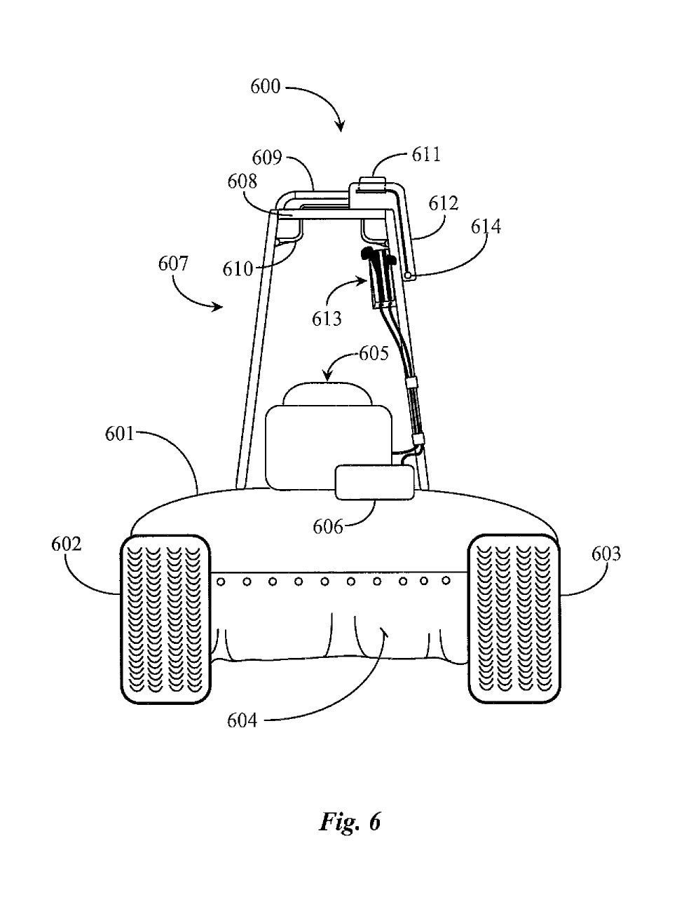

FIG. 6 is a front view of a lawnmower 600 with a material chassis skirt installed according to an embodiment of the present invention. Lawnmower 600 is a typical clutch-driven lawnmower adapted with the track system of the present invention. Mower 600 includes a chassis 601, tracked wheel sets 602 (right wheels) and 603 (left wheels), a mower engine 605 and a throttle mechanism 606. The mower is operated from behind by controls provided on a push handle 607 as is the case with virtually all clutch-driven mowers and brush cutters.

In this example, a control box 613 is mounted to a main mower handle assembly 607. Control box 613 includes at least one control lever for engine speed and may include an additional lever for choke or some other function depending on the mower model and type. The handle assembly includes a bracket 612 connected to a pivotally attached handle 609. Another pivotally attached handle 610 is provided. Handles 609 and 610 are spring loaded at their pivot points with the main handle of the mower and for safety purposes, must be physically held together in order for the blade, engine and clutch to be operating simultaneously to mow grass. The typical setup is for a mower handle assembly would be that handle 610 trigger the engine cut-off when it is released and for handle 609 trigger blade and clutch disengagement when it is released. A separate trigger for blade rotation is provided in this example as kill switch 611.

One feature that is not found on a typical clutch-driven mower is a cable assisted braking feature. Therefore, if a user kills the blades of the mower but does not release the clutch of the mower the utility can continue forward unplanned. Therefore, the inventor provides a breaking assembly applied to the rear power wheel of the mower or utility vehicle that can be triggered at the same time that the blades are triggered. The cable of the breaking system is anchored in this example on bracket 614 and leads to the assembly at the wheel, which is describe more fully below.

Also in this example as was described with respect to FIG. 5, the front of the blade housing is open by virtue of removal of a front housing wall if provided or by cutting out the appropriate portion of the housing if it is a solid cast. Generally speaking, the front housing is a safety feature of existing mowers that prevents someone from getting a foot or some other important body part under the mower while the blades are rotating. By removing this feature, and extending the length of the chassis if necessary, the same safety level is provided by the fact that the extension is longer than a human foot or elbow length so that through the front a user still cannot reach rotating blades. Removing the front housing wall also enables more of an air flow into the mower from the front, which aids in vacuuming capabilities of the system originally resulting from addition of the blade-housing cover plates described further above and assumed part of the configuration in this example.

A rough material skirt 604 such as a rough leather is provided and mounted to the front of the mower chassis for cosmetic appearance and to protect the blade field from mobile debris from entering the mowing field of the mower inadvertently while enabling smaller debris like dirt, leaves, twigs, and the like to enter and be vacuumed. In this example, the skirt is attached across the top by rivet or by snap, or by bolt and nut. The skirt may also server to prevent kick-out of objects by the mower as would the original front housing plate.

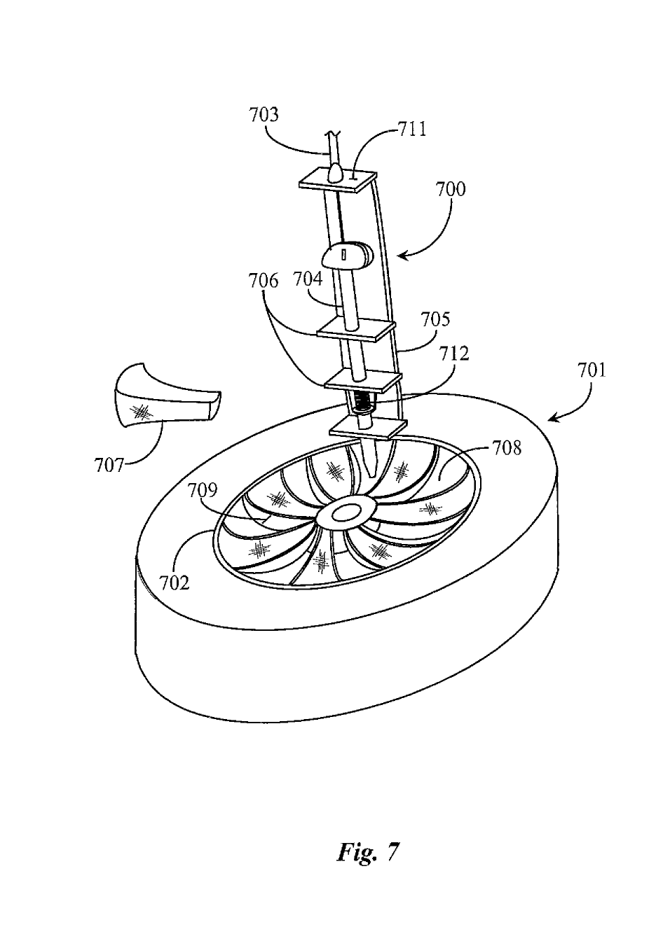

FIG. 7 is a perspective view of the inside of a lawnmower wheel 701 illustrating a cable-assisted break and plug system according to an embodiment of the present invention. Wheel 701 is illustrated in this example without a track belt installed. Generally speaking, the wheel of a lawn-type vehicle includes a rim 702 that is structurally reinforced by support ribs 709 arranged angularly and according to equal space around the rim. Support ribs 709 contribute to lighter wheels without compromising structural support for the wheel.

A cable assisted break is provided in the form of a spring assisted break-pin that when activated by releasing the break handle immediately stops the forward motion of the utility even if the clutch is engaged.

The support ribs 709 of rim 702 are generally too fragile to hold a break pin against forced forward motion with the engine off and in gear or in neutral. Empirical testing confirmed that the ribs would break being of a rather fragile or brittle plastic.

Therefore, the inventor has provided a rubber reinforcement plug illustrated herein apart from wheel 701 as a plug 707. Plug 707 may be a heavy rubber plug molded to a shape like a rib compartment 708 flanked by two ribs 709 in the wheel rim 702 and may be inserted tightly into such a compartment to fill the compartment and at the same time to strengthen the ribs. In this case a plug 707 is inserted into every other wheel compartment 708 in rim 702 totaling 7 plugs in all. The remaining 7 compartments 708 that are empty are able to receive a break pin safely and without damage. Each rib 709 flanking a compartment 708 is now reinforced by an adjacent rubber plug. Plug 707 may also be made of a polymer material. Plugs 707 may be press fit or tapped into compartments 708 and are adapted to remain within the wheel rim permanently when installed.

In this example, a typical break-pin system 700 is provided that may be bracketed on the chassis at the back wheel in position to be operated according to spring load and cable release to cause automatic and instant breaking at lever release. System 700 includes a break plate 705, a break pin 704 and pin guide brackets 706 (3 total). Assembly 700 further includes a cable/pin holder 710 adapted to attach the end of the pin and to anchor the cable enabling the pin to be released and to be retracted against the force of a spring 712. Other break/pin assembly designs may be used without departing from the spirit and scope of the invention. The benefit of having an emergency break pin system is that a user may stop the utility vehicle from rolling on an incline or to prevent unintended movement.

In one embodiment, the inventor also provides a pivot plate (not illustrated) that is a modified version of an existing plate that enables height adjustment of the wheels of a lawnmower or other utility vehicle in a way that does not change the distance between the front and rear wheels during the adjustment. Generally speaking, height is adjustable at the rear axle wheel of a lawnmower by lever or pin wherein the axle is designed to be pivoted to raise or lower the wheel set. In some models wheels are adjustable as sets both in the front and rear of the mower or brush cutter.

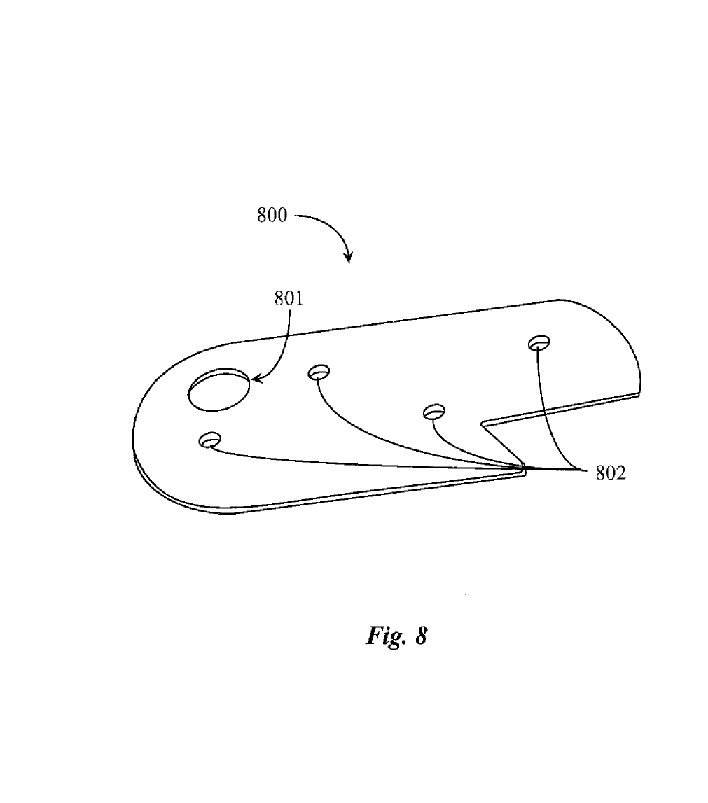

FIG. 8 is an elevation view of a height adjustment pivot plate 800 for adjusting height without changing wheelbase length.

One problem with height adjustment on a mower with the track belt system is that making a height adjustment can change the distance between the front and rear wheels necessitating a further adjustment of the tension adjuster bar to compensate. The inventor has solved the problem by providing equal pivot points made available by pivot plates for all of the wheels so that when one set is raised or lowered, the distance between the front and back sets remains exactly the same. In this way no additional adjusting of a tension bar is required to prevent track belt slippage against the wheel surface. Plate 800 includes an opening for the wheel axle and plate position openings 802 for optional height adjustment. Plate 800 is preferable cut from stainless steel or other durable sheet metal.

It will be apparent to one with skill in the art that the track and tensioning system of the present invention may be provided using some or all of the mentioned features and components without departing from the spirit and scope of the present invention. It will also be apparent to the skilled artisan that the embodiments described above are exemplary of inventions that may have far greater scope than any of the singular descriptions. There may be many alterations made in the descriptions without departing from the spirit and scope of the present invention.

What is claimed is:

1. A system for improving maneuverability and safety of a clutch driven landscaping utility vehicle comprising:
a set of vehicle track belts comprising one track belt per set of front and rear wheels;
a tension adjuster for controlling tension of the track belts over the wheels; and
a track guard for preventing debris from dislodging the track belt during operation.

2. The system of claim 1 wherein the utility vehicle is a lawnmower.

3. The system of claim 1 wherein the track belt has opposing sidewalls and a center ridge located peripherally about the inward facing service of the belt, the wheels having a center groove located peripherally around the outside surfaces thereof, the grooves adapted to accept the center ridge.

4. The system of claim 1 wherein the tension adjuster is a bar assembly installed on both ends at the hubs of the wheels.

5. The system of claim 4 wherein the track guard is installed on the tension bar assembly.

6. The system of claim 1 further comprising a pair of cover plates affixed to the lateral sides of a blade housing compartment of the utility vehicle.

7. The system of claim 6 wherein the utility vehicle is a lawnmower.

8. The system of claim 6 wherein the system is used to vacuum up debris.

9. The system of claim 6 wherein the cover plates are bolted or riveted to the blade housing.

10. The system of claim 6 further comprising an open modified chassis front with a material skirt affixed thereto.

11. The system of claim 10 wherein the skirt is leather.

12. The system of claim 1 further including an emergency breaking system activated by handle release.

13. The system of claim 6 further including an emergency breaking system activated by handle release.

14. The system of claim 1 further including pivot plates for enabling wheel height adjustment without changing wheel base dimension.
